(19) United States
(12) Patent Application Publication
(10) Pub. No.: US 2012/0242567 A1
(43) Pub. Date: Sep. 27, 2012

(54) HAND-HELD DISPLAYING DEVICE

(75) Inventor: Min-Chih HSUAN, Hsinchu City (TW)

(73) Assignee: Smile Technology Co., Ltd., Mahe (SC)

(21) Appl. No.: 13/070,746

(22) Filed: Mar. 24, 2011

(51) Int. Cl. G06F 3/01

(52) U.S. Cl. 345/156

(57) ABSTRACT

The hand-held displaying device comprises a displaying panel to display at least one color and its brightness, a motion sensor to detect motions of the motion sensor and a controller to control contents of displays in the displaying panel according to motions detected by the motion sensor. The displaying panel may include a plurality of displaying regions, each being able to display at least one color and its brightness and respectively controlled by the controller. The displaying device may provide a sound generating element and a loudspeaker. The controller may provide a memory space to record a series of displayed to be played back in a later time.

### FIELD OF THE INVENTION

The present invention relates to a displaying device, especially a hand-held displaying device. The present invention discloses an intellectual displaying device that changes the contents to be displayed in response to the shaking and knocking motions of the displaying device, as activated by the holder of the displaying device.

### BACKGROUND OF THE INVENTION

In participating in an amusement, sports, gathering, performance and other activities, and even when calling for help, a hand-held displaying device, such as an electronic cheer stick, that produces sounds and lights is desirable. The conventional cheer stick may be divided into two categories. The first one is the cheer sticks that produce sounds when the holder knocks or blows the cheer stick. The other one is the cheer sticks that produce lights under the control of the holder. In the latter type, the cheer stick is provided with a lighting device that generates lights in response to the switching operations of the holder.

While the conventional cheer sticks generate sound and lighting effects, their functions are very simple. They can not produce sophistic sound and lighting effects and variations. In addition, the conventional cheer sticks provide only a limited number of displaying patterns.

Nevertheless, in operating the conventional cheer stick, the users wave, shake or knock the cheer stick, in order to express their passions and feelings. When operating the cheer stick in such a radical manner, it is almost impossible for the user to conduct any sophisticate, or at least complicated controls in the display of the cheer stick. Therefore, even if the cheer stick is provided with function keys that lead to complicated displaying functions, the users would find them almost useless, since they won't have the leisure to make use of these function keys.

Therefore, it is necessary to provide a displaying device that is able to product the sophisticate sound and lighting effects, while the control of the sophisticate effects is made easier.

### OBJECTIVES OF THE INVENTION

The objective of this invention is to provide a hand-held displaying device that provides a variety of displaying effects.

Another objective of this invention is to provide a hand-held displaying device that produces the sound and lighting displaying effects.

Another objective of this invention is to provide a hand-held displaying device that is easy to control, without any complicated operations.

Another objective of this invention is to provide a hand-held displaying device that changes its displaying contents in response to the motions of the holder.

Another objective of this invention is to provide a hand-held displaying device that automatically changes the displaying contents in accordance with the environmental conditions.

### SUMMARY OF THE INVENTION

According to the present invention, a hand-held displaying device is disclosed. The hand-held displaying device of this invention comprises: a display panel to produce at least one color and its brightness; a motion sensor to detect the motions of the hand-held displaying device and convert the detected motions into motion parameters; a controller to control contents of displays in said display panel, according to motion parameters detected by said motion sensor; a power supply to supply power to said display panel, said motion sensor and said controller; and a main body to hold said power supply, said display panel, said motion sensor and said controller. In another embodiment of this invention, the hand-held displaying device further comprises a switch to control the operation of said power supply. In another embodiment of this invention, the hand-held displaying device further comprises a display control key, to control contents of display in said displaying panel in response to the manual operations of the display control key. In another embodiment, the invented hand-held displaying device comprises a plurality of displaying regions, each being able to display at least one color and its brightness. In such an embodiment, the plurality of the displaying regions is arranged in a rectangular shape. In such an embodiment, the controller controls the colors being displayed in each displaying region and their brightness.

In another embodiment, the invented hand-held displaying device further comprises a voice input element and a speaker and the power supply supplies electric power to said sound input element and speaker. Said voice input element may be a microphone. In another embodiment, the invented hand-held displaying device further comprises a sound generation element and a loudspeaker and the power supply supplies electric power to said sound generation element and loudspeaker. The sound generation element may be a sound generation IC, to generate predetermined sounds and provide such sounds to the loudspeaker. Yet, in another embodiment of this invention, the display control key comprises a fine-tune switch, to control the brightness in the colors displayed in the displaying panel. In another embodiment of the invented hand-held displaying device, the controller provides a memory space to store at least one file that represents a series of displays, whereby the controller reproduces said series of display in said displaying panel.

These and other objectives and advantages of the present invention may be appreciated from the detailed description by referring to the following drawings.

### BRIEF DESCRIPTION OF THE DRAWING

FIG. 1 illustrates the schematics of the hand-held displaying device of this invention.

### DETAILED DESCRIPTION OF THE INVENTION

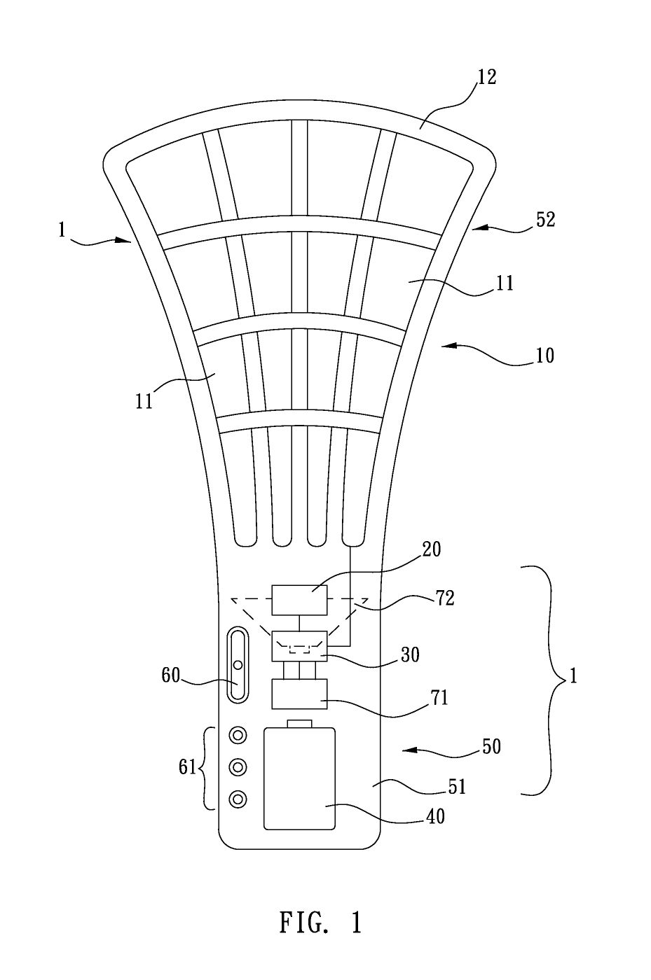

FIG. 1 illustrates the schematics of the hand-held displaying device of this invention. As shown in this figure, the invented hand-held displaying device comprises a displaying panel 10, a motion sensor 20, a control 30 and a power supply 40, all held in a frame 50 that forms the main body of the hand-held displaying device of this invention with a longitudinal shape. The main body 50 illustrated in the figure is fan-shaped and forms a cylinder at the root portion, where may be the handle 51 of the displaying device. The size of the toot portion is preferably that may be held by the hand. The functions of the main body include to hold and to support the elements of the displaying device 1 and to provide a section that may be held by the hand, so to increase the visuality of the contents being displayed in the displaying panel 10. To satisfy such requirements, the shape of the root potion is not limited to the cylinder shape. Other shapes that fit for hand-holding, such as the square column, triangular column, oval column and other variations are also applicable in this invention. Similarly, the displaying portion 52 of the displaying device 1 is not limited to the fan shape. Any other shape that is suited for the installation of the displaying panel 10 may be used in this invention. Applicable shapes include planar shapes, such as the rectangular shape, the circular shape, the hexangular shape etc. and non-planar shapes with any contour, such as a display panel with a cambered surface, with the cylinder shape, the conical shape etc. In general, the hand-held displaying device may have the shape similar to that of the conventional cheer stick, with a middle section that produces sounds when knocked would be a preferable example.

The functions of the displaying panel 10 are to display particular colors and their combinations. FIG. 1 illustrates that the displaying panel includes a plurality of displaying regions 11, 11, arranged in a rectangular shape. The frame 12 separates and supports the displaying regions 11, 11. The materials of the frame 12 are not limited to any particular material. However, the materials that are light in weight and rigid in strength are most preferable. Generally speaking, the plastic material is one suited material. Other materials such as fiber glass, metal or composite materials are also applicable in this invention. Each displaying region 11, 11 is able to display at least one color and its brightness. An exemplary example of the displaying region 11, 11 is a single-color or multiple-color light emitting element with light emitting diodes embedded therein, covered by a diffuser. In such a device, the light emitting diode may be any single-color or multiple-color light emitting diode commercially available in the market. The diffuser may be any commercially available diffusing plate, diffusing sheet or diffusing membrane. The material of the diffuser is not limited to any particular material. Suited materials include the polycarbonate sheet but this is not any technical requirement. The wires (not shown) of the light emitting element may couple with the wires that are embedded in the frame 12 and connected with the power supply 40, whereby the power supply 40 supplies electric power to the light emitting element. The controller 30 controls the power supply 40, so to control the light emitting or not emitting operations of the light emitting element and the color and brightness of the emitted lights. In other embodiments of this invention, the displaying panel does not have a plurality of displaying regions, but rather, only one displaying region. This arrangement is particularly advantageous, when the invented displaying device is used as a cheer stick, because the fabrication costs would be dramatically reduced.

The power supply 40 shown in the figure is a battery that provides the advantage of lower costs. The battery also functions as the weight of the hand-held displaying device. It would be appreciated that other types of the portable power supply, or even a plug connectable to a socket and a converter, may also be used in this invention. In this figure, a switch 60 is also shown. The switch 60 controls the power supply but is not an essential element in this invention. If the switch 60 is used, it may be any known switching element, with the fine-tune switch being a preferable example.

The motion sensor 20 is one of the important features of this invention. The motion sensor 20 may be any sensor that is able to detect the movements of the sensor 20 itself, i.e. the movements of the displaying device 1, and convert the detected movement in to motion parameters, such as parameters that represent the direction, speed, distance etc. of a motion. The motion sensor 20 outputs the detected motion parameters according to particular clock cycles. Motion sensors suited in this invention include an accelerator or a gyroscope. The motion sensor may be positioned in the fan-shape region or in the handle region. The accelerator or the gyroscope may detect the position and orientation of the displaying device and the speed, distance, duration, magnitude, direction and time and their variations of a movement, and generate signals to represent such parameters. The post-stage circuits may convert such detected signals into motion parameters for output. Any conventional accelerator or gyroscope may be used in this invention. The recent developments in the microelectronic machine system have provided a microprocessor that is integrated with an accelerator or a gyroscope. Such sensor-microprocessor integration is preferable in this invention, since it serves as both the motion sensor 20 and the controller 30 of this invention. Since the integrated microprocessor-accelerator or microprocessor-gyroscope is known to those skilled in the art, detailed descriptions thereof are thus omitted.

The design of the controller 30 is another important feature of this invention. According to the embodiments of this invention, the controller 30 functions to obtain the motion parameters generated by the motion sensor 20, interpret the motion parameters and control the displaying contents of the displaying panel 10 in accordance with the values of the motion parameters. In one embodiment, the controller determines the motion conditions of the motion sensor 20, i.e, the displaying device 1, according to the values of the motion parameters output by the motion sensor, thereby to control the displaying contents of the displaying panel 10. That is, the controller 30 determines the motion condition of the motion sensor 20, i.e, the displaying device 1 to be moderate or violent, according to the values of the motion parameters generated by the motion sensor 20 and controls the displayed contents in the display panel 10. For example, the controller 30 determines whether the motions of the displaying device, as activated by the swinging, shaking, knocking operations of the holder, is moderate or violent, according to the values of the motion parameters provided by the motion sensor and control the displaying contents in the displaying panel 10.

In such an application, the parameters that the motion sensor 20 outputs include the variation values in the position and/or direction of the motion sensor 20, within particular clock cycle. The controller 30 determines whether the motion, such as shaking, waving or knocking, is moderate or violent, and their weights in accordance with equations known to those skilled in the art.

Also in such an application, the controller 30 may be programmed to blink the light emitting diodes in the displaying panel 10 in a low frequency in accordance with the rhythm of waving of the displaying device, when it determines that the displaying device 1 is swinging slowly. In another embodiment, the controller 30 may be so programmed that it varies the brightness of the light emitting diodes in the displaying panel 10 in a lower speed, when it determines that the displaying device 1 is swinging slowly but varies the brightness of the light emitting diodes in the displaying panel 10 in a higher speed, when it determines that the displaying device 1 is swinging quickly. In a further other embodiment, the controller 30 is so programmed that it varies the color, brightness, their combinations and varying speed of the displaying images in the displaying panel 10, when it determines the displaying device 1 swings slowly. Other methods and patterns in the control of the displaying contents may also be programmed and used in this invention.

When the displaying panel 10 has a plurality of displaying regions 11, 11, the controller 30 may control the displaying contents of each displaying region 11, 11 in the displaying panel 10, in accordance with the character of the motions of the displaying device, calculated in pursuance with the motion parameters provided by the motion sensor 20.

In yet another embodiment of the present invention, the displaying device 1 further include a display control key 61, coupled with the controller 30, to control the displaying contents in the displaying panel 10 in accordance with the manual control operations of the holder. In the display control key 61 of the embodiment of FIG. 1, 3 push-buttons are shown. In this example they respectively control the colors and their brightness to be displayed in the displaying panel 10. In other applications, the display control key 61 may be one or more pressure sensors, to output control signals in response to the movement and the pressure of the user's finger or fingers, in respect to the pressure sensor, in order to facilitate the controller 30's controls in the displaying contents of the displaying panel 10. These push-buttons and pressure sensors may be any commercially available component. It is also preferable to integrate the pressure sensor 61 with the controller 30, in the form of a single chip.

In other embodiments of this invention, the displaying device 1 may further comprise a sound generator 71 and a loudspeaker 72, both accept the electric power from the power supply 40. The loudspeaker 72 may be any commercially available speaker, preferably positioned at the bottom of the displaying portion 52, where the displaying portion 52 connects the handle 51. In such an example, the displaying portion 51 is preferably in a corn shape, whereby the sounds generated by the loudspeaker 72 may be amplified by the corn-shaped displaying portion 51. Of course, this is not any technical limitation to the present invention. The sound generator 71 may also be any commercially available sound chip that generates particular sound signals to the loudspeaker 72 for amplification in accordance with the control signals of the controller 30. The sound generator 71 may also be integrated into the IC chip that contains the controller 30. They may further be integrated with the motion sensor 20.

In the embodiment described above, the controller 30 may further determine the shaking or swinging status of the displaying device 1 according to the motion parameters output by the motion sensor 20 and control and vary along with time the features of the sounds that the sound generator 71 generates, such as the frequency, phase, amplitude, spectrum distribution, waveform envelope etc. of the sounds. For example, the control 30 may be programmed to send no instruction to the sound generator 71, when the displaying device 1 is being waved moderately, and send instructions to the sound generator 71, having the sound generator 71 produce sounds, when the magnitude, speed and/or intensity of the waving or shaking motions of the displaying device exceeds a threshold. The controller 30 may be further programmed to vary the tone and/or volume of the generated sounds, if fierce waving motions of the displaying device 1 are detected, and generate blast sounds, if the intensity of the waving motions exceeds another threshold. These and other patterns of the sound controls and their combinations with the patterns of the display controls in the displaying panel 10 may also be used in the present invention.

In yet another embodiment of this invention, the displaying device 1 further comprises a voice input element (not shown). The voice input element may be a commercially available microphone, coupled to the loudspeaker 72. The holder of the displaying device 1 may speak or shout to the microphone and the loudspeaker 72 reproduces the voices in an amplified magnitude. It is preferable to use a micro-microphone as the voice input element, so that it may be integrated with the controller in one chip. The power needed by the voice input element may be supplied by the power supply 50.

The controller 30 that provides the functions as described above may be any commercially available microcontroller or microprocessor. In general, a controller IC that integrates an accelerator or a gyroscope with a microcontroller is preferable, while those skilled in the art may use a particular microcontroller or microprocessor chip in association with other circuits, to accomplish the controller 30. Since such applications are obvious to those skilled in the art, detailed description thereof is thus omitted.

In one embodiment of the present invention, the controller 30 provides a memory space (not shown) to store at least one file that represent the records of a series of displays performed in the displaying device 1. The recorded series of displays may be replayed in the display panel 10 under the control of the controller. Such applications may also be accomplished using said commercially available microcontroller or microprocessor. However, to facilitate such applications the displaying device 1 needs to provide a record key, a reproduce key, selection keys and even a control panel (all not shown). These keys, of course, may be replaced by the combined operations of the existing control keys, such the switch 60 and the display control key 61, so to reduce the number of control keys and the space of the control panel used in the invented device. These objectives may also be easily accomplished by those skilled in the art and their details are thus omitted.

A displaying device 1 with the elements and functions as described above may initialize and vary the contents of displays in the displaying panel 10 and the sounds and voices generated by the loudspeaker 72, according to the waving, shaking, knocking and other motions of the displaying device 10 operated by the holder. The invented displaying device may thus be used in all kinds of amusement, gathering, sports and other public activities.

As the structure, elements, functions, applications and effects of the present invention has been shown and described with reference to preferred embodiments thereof, those skilled in the art will recognize that the above and other changes may be made therein without departing form the spirit and scope of the invention.

What is claimed is:

1. A hand-held displaying device, comprising:
a displaying panel to display at least one color and its brightness;
a motion sensor to detect motions of said motion sensor and to convert results of said detection into motion parameters;
a controller to control contents of displays in said displaying panel, according to said motion parameters of said motion sensor;
a power supply to supply electric power to said display panel, said motion sensor and said controller; and
a main body to support said power supply, said display panel, said motion sensor and said controller.

2. The hand-held displaying device according to claim 1, further comprising a switch to control operations of said power supply.

3. The hand-held displaying device according to claim 1, further comprising a display control key, to control contents of displays in said displaying panel in response to manual operations of said display control key.

4. The hand-held displaying device according to claim 1, wherein said displaying panel comprises a plurality of displaying regions, each being able to display at least one color and its brightness.

5. The hand-held displaying device according to claim 4, wherein said plurality of the displaying regions is arranged in a rectangular shape.

6. The hand-held displaying device according to claim 4, wherein said controller controls colors being displayed in each displaying region and their brightness.

7. The hand-held displaying device according to claim 5, wherein said controller controls colors being displayed in each displaying region and their brightness.

8. The hand-held displaying device according to claim 1, further comprising a voice input element and a speaker and wherein said power supply supplies electric power to said sound input element and speaker.

9. The hand-held displaying device according to claim 5, wherein said voice input element comprises a microphone.

10. The hand-held displaying device according to claim 1, further comprising a sound generation element and a loudspeaker and wherein said power supply supplies electric power to said sound generation element and loudspeaker.

11. The hand-held displaying device according to claim 10, wherein said sound generation element comprises a sound generation IC, to generate predetermined sounds and provide such sounds to said loudspeaker.

12. The hand-held displaying device according to claim 1, wherein said display control key comprises a fine-tune switch, to control brightness in said colors displayed in said displaying panel.

13. The hand-held displaying device according to claim 1, wherein said controller provides a memory space to store at least one file that represents a series of displays, whereby said controller reproduces said series of display in said displaying panel.

14. The hand-held displaying device according to claim 1, wherein said main body comprises a corn shape.
